(19) United States
(12) Patent Application Publication
(10) Pub. No.: US 2006/0031474 A1
(43) Pub. Date: Feb. 9, 2006

(54) Maintaining reachability measures

(76) Inventor: Linden Cornett, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/894,501

(22) Filed: Jul. 19, 2004

(51) Int. Cl. G06F 15/173

(52) U.S. Cl. 709/224

(57) ABSTRACT

In general, in one aspect, the disclosure describes a method of, at different times, comparing multiple reachability measures of a remote device, and if the reachability measures of the remote device differ, setting the reachability measures to the same value.

### REFERENCE TO RELATED APPLICATIONS

This relates to U.S. patent application Ser. No. 10/815,895, entitled “ACCELERATED TCP (TRANSPORT CONTROL PROTOCOL) STACK PROCESSING”, filed on Mar. 31, 2004; an application entitled “DISTRIBUTING TIMERS ACROSS PROCESSORS”, filed on Jun. 30, 2004, and having attorney/docket number 42390.P19610; and an application entitled “NETWORK INTERFACE CONTROLLER INTERRUPT SIGNALING OF CONNECTION EVENT”, filed on Jun. 30, 2004 , and having attorney/docket number 42390.P19608.

### BACKGROUND

Networks enable computers and other devices to communicate. For example, networks can carry data representing video, audio, e-mail, and so forth. Typically, data sent across a network is divided into smaller messages known as packets. By analogy, a packet is much like an envelope you drop in a mailbox. A packet typically includes “payload” and a “header”. The packet's “payload” is analogous to the letter inside the envelope. The packet's “header” is much like the information written on the envelope itself. The header can include information to help network devices handle the packet appropriately.

A number of network protocols cooperate to handle the complexity of network communication. For example, a transport protocol known as Transmission Control Protocol (TCP) provides “connection” services that enable remote applications to communicate. That is, TCP provides applications with simple commands for establishing a connection and transferring data across a network. Behind the scenes, TCP transparently handles a variety of communication issues such as data retransmission, adapting to network traffic congestion, and so forth.

To provide these services, TCP operates on packets known as segments. Generally, a TCP segment travels across a network within (“encapsulated” by) a larger packet such as an Internet Protocol (IP) datagram. Frequently, an IP datagram is further encapsulated by an even larger packet such as an Ethernet frame. The payload of a TCP segment carries a portion of a stream of application data sent across a network by an application. A receiver can restore the original stream of data by reassembling the payloads of the received segments. To permit reassembly and acknowledgment (ACK) of received data back to the sender, TCP associates a sequence number with each payload byte.

Many computer systems and other devices feature host processors (e.g., general purpose Central Processing Units (CPUs)) that handle a wide variety of computing tasks. Often these tasks include handling network traffic such as TCP/IP connections. The increases in network traffic and connection speeds have placed growing demands on host processor resources. To at least partially alleviate this burden, some have developed TCP Off-load Engines (TOEs) dedicated to off-loading TCP protocol operations from the host processor(s).

### BRIEF DESCRIPTION OF THE DRAWINGS

FIGS. 1A and 1B illustrate a sample system that maintains reachability measures.

FIGS. 2A-2C illustrate synchronizing and aging of reachability deltas.

FIG. 3 is a flow-chart of a process to reset a reachability delta.

FIG. 4 is a flow-chart of a process to synchronize and age reachability deltas.

### DETAILED DESCRIPTION

In a connection, a pair of end-points may both act as senders and receivers of packets. Potentially, however, one end-point may cease participation in the connection, for example, due to hardware or software problems. In the absence of a message explicitly terminating the connection, the remaining end-point may continue transmitting and retransmitting packets to the off-line end-point. This needlessly consumes network bandwidth and compute resources. To prevent such a scenario from continuing, some network protocols attempt to gauge whether a communication partner remains active. After some period of time has elapsed without receiving a packet from a particular source, an end-point may terminate a connection or respond in some other way.

As an example, some TCP/IP implementations maintain a table measuring the reachabillity of different media access controllers (MACs) transmitting packets to the TCP/IP host. This table is updated as packets are received and consulted before transmissions to ensure that a packet is not transmitted if a connection has “gone dead”. However, in a system where multiple processors of a host handle traffic, coordinating access between the processors to a monolithic table can degrade system performance, for example, due to locking and cache invalidation issues.

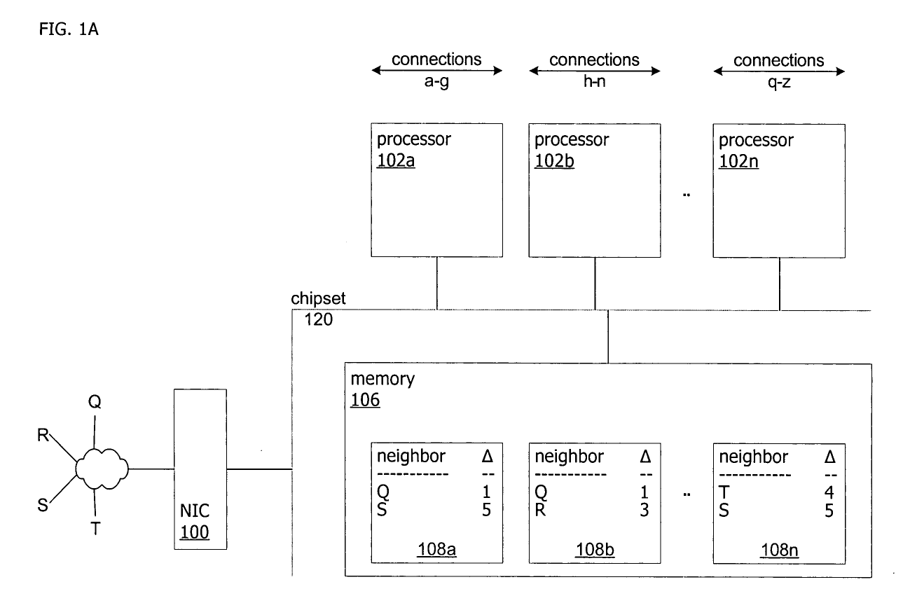

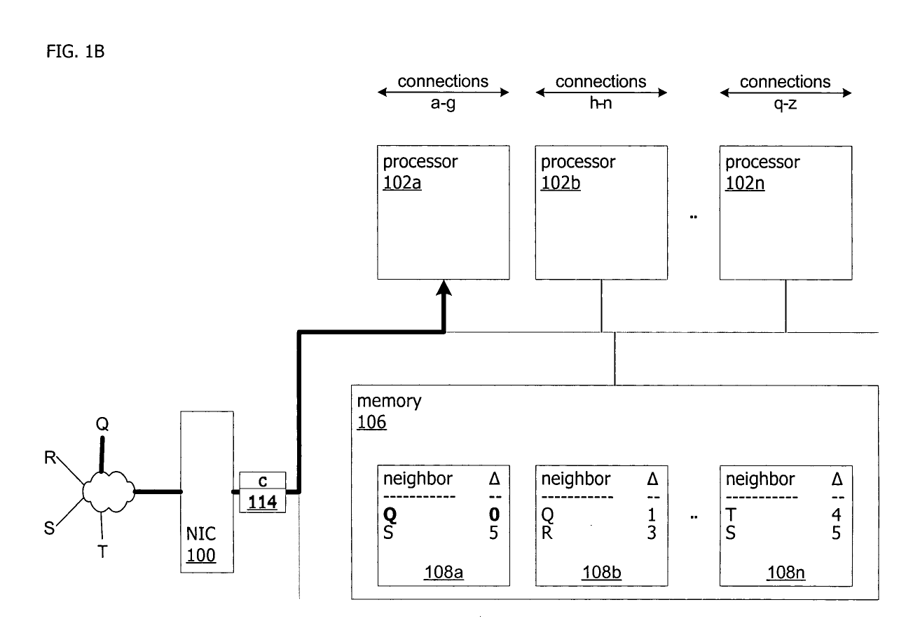

FIG. 1A illustrates a scheme that features state data 108a-108n associated with different processors 102a-102n. As shown, the state data 108a-108n lists multiple neighboring devices (e.g., by media access controller (MAC) address) and a corresponding reachability measure (e.g., a timestamp or delta). In this case, the reachability measure is a delta value that is periodically incremented. Each processor 102a-102n can update its corresponding neighbor state data 108a-108n for packets handled. For example, a processor 108a may reset the delta value for a particular neighbor after receiving a packet from the device. By each processor 102a having its own associated set of neighbor state data 108a, the state data 108a can be more effectively cached by the processor 102a. Additionally, the scheme can reduce inter-processor contention issues.

In greater detail, the sample system of FIG. 1A includes multiple processors 102a-102n, memory 106, and one or more network interface controllers 100 (NICs). The NIC 100 includes circuitry that transforms the physical signals of a transmission medium into a packet, and vice versa. The NIC 100 circuitry also performs de-encapsulation, for example, to extract a TCP/IP packet from within an Ethernet frame.

The processors 102a-102b, memory 106, and network interface controller(s) are interconnected by a chipset 120 (shown as a line). The chipset 120 can include a variety of components such as a controller hub that couples the processors to I/O devices such as memory 106 and the network interface controller(s) 100.

The sample scheme shown in FIG. 1A does not include a TCP off-load engine. Instead, the system distributes different TCP operations to different components. While the NIC 100 and chipset 201 may perform and/or aid some TCP operations (e.g., the NIC 100 may compute a segment checksum), most are handled by processor's 102a-102n.

As shown, different connections may be mapped to different processors 102a-102n. For example, operations on packets belonging to connections (arbitrarily labelled) “a”to “g” may be handled by processor 102a, while operations on packets belonging to connections “h” to “n” are handled by processor 102b.

FIG. 1B illustrates receipt of a packet 114 transmitted via remote MAC “Q”. As shown, the NIC 100 determines which of the processors 102a-102n is mapped to the packet's connection, for example, by hashing data in the packet's 114 header(s) (e.g., the IP source and destination addresses and the TCP source and destination ports). In this example, the packet 114 belongs to connection “c”, mapped to processor 102a. The NIC 100 may queue the packet 114 for the mapped processor 102a (e.g., in a processor-specific Receive Queue (not shown)).

As shown, the neighbor state data 108a associated with processor 102a may be updated to reflect the packet 114. That is, as shown, the processor 102a may determine the neighbor, “Q”, that transmitted the packet 114, lookup the neighbor's entry in the processor's 102a associated state data 108a and set the neighbor's reachability delta to 0.

Periodically, a process ages the neighbor state data, for example, by incrementing each delta. For example, in FIG. 1B, at least “3” increment operations have occurred since the last packet was received from neighbor “R”. The delta can, therefore, provide both a way of determining when activity has occurred (because the delta has been reset) and a way of determining whether a particular neighbor is “stale”. Again, if the delta exceeds some threshold value, a processor may prevent further transmissions to the neighbor and/or initiate connection termination. For example, a processor may lookup a neighbor's delta before a requested transmit operation.

Potentially, the neighbors monitored by the different processors 102a- 102n may overlap. For example, in FIG. 1A, an entry for neighbor “Q” is included in both the state data 108a associated with processor 102a and the state data 108b associated with processor 102b. One reason for this overlap is that, potentially, multiple connections may travel through the same remote device. For example, multiple connections active on a remote host may travel through the same remote MAC but be processed by different processors 102a-102n. Phrased differently, two packets may travel through the same neighboring MAC but be mapped to different processors 102a-102n. In the scheme illustrated above, these two different packets will cause each processor to update its reachability measure for this neighbor. If these packets are received at different times, however, this will cause an inconsistency between the different reachability measures for a given neighbor in the different sets of data. That is, at time “x”, one processor 102a may reset its measure for a neighbor in its associated state data 108a while, at time “y”, a different processor 102b subsequently resets its measure for the same neighbor.

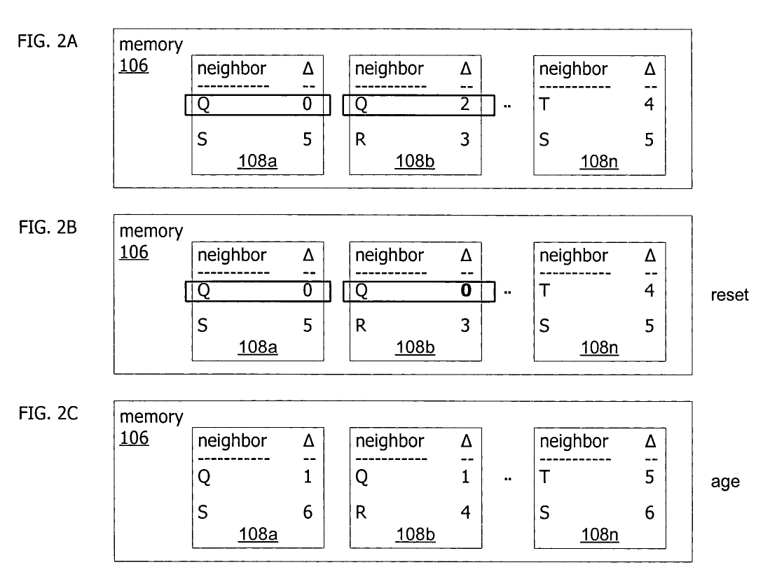

To maintain consistency across the different sets of data 108a-108n, FIGS. 2A-2C illustrates a process that can synchronize the different measure values. As shown, the same process may also be used to age the measures.

To synchronize, the process can access the different deltas for a given neighbor and set each to the lowest delta value. For example, as shown in FIG. 2A, the process compares the different values for neighbor “Q”. In this example, the reachability measure for “Q” in the data 108b associated with processor 102b has been aged twice while processor 102a recently received a packet from neighbor “Q” and reset “Q”-s delta. As shown in FIG. 2B, to reflect the most recent neighbor activity detected by any of the processors 102a- 102n, the process sets both delta values for “Q”to the lesser of the two current delta values (“0”). As shown, in FIG. 2C, the process then ages each of the reachability measures of each neighbor in the data 108a associated with each participating processor 102a-102n.

The process illustrated in FIGS. 2A-2C may be scheduled to periodically execute on one of the processors 102a- 102n. Because protocols are often tolerant of some degree of connection staleness, the time period between executions may be relatively large (e.g., measured in seconds or even minutes).

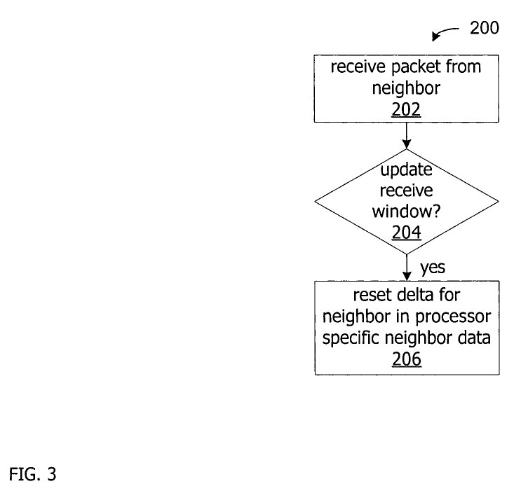

FIG. 3 depicts a reachability measure update process 200 each processor handling packets can perform. As shown in response to a received 202 packet, the process 200 can update 206 the reachability measure for the neighbor transmitting the packet. Potentially, the process 200 may only update the measure in certain circumstances, for example, if 204 the packet updates the connection's receive window (e.g., the packet includes the next expected sequence of bytes).

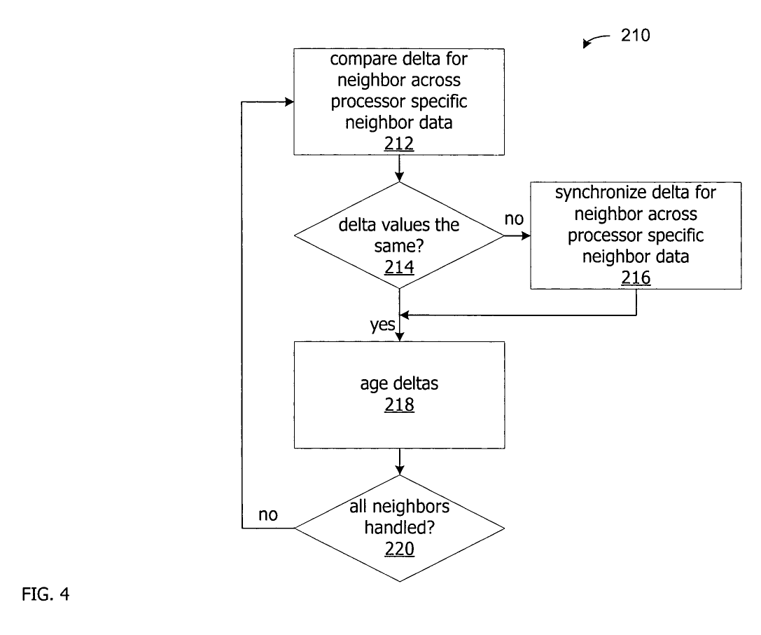

FIG. 4 depicts a process 210 used to synchronize and age the reachability measures across the different sets of state data 108a-108n. As shown, for each neighbor 220, the process 210 compares 212 the reachability delta for the neighbor across the different sets of state data associated with the different processors. If the deltas differ 214, the process 210 can set each delta to the same value (e.g., the lowest of the delta values). The process 210 also ages 218 each measure. The process 210 shown is merely an example and a wide variety of other implementations are possible.

The techniques described above may be used in a variety of computing environments such as the neighbor aging specified by Microsoft TCP Chimney (see “Scalable Networking: Network Protocol Offload—Introducing TCP Chimney” WinHEC 2004 Version). In the Chimney scheme, before transmitting a segment, an agent (e.g., a processor or TOE) accesses a neighbor state block to ensure that a neighbor has some receive activity that advanced a TCP window within a certain threshold amount of time (e.g., Network Interface Control (NIC) Reachabilty Delta<‘NCEStaleTicks’). If the neighbor is stale, the offload target must notify the stack before transmitting the data.

Though the description above repeatedly referred to TCP as an example of a protocol that can use techniques described above, these techniques may be used with many other protocols such as protocols at different layers within the TCP/IP protocol stack and/or protocols in different protocol stacks (e.g., Asynchronous Transfer Mode (ATM)). Further, within a TCP/IP stack, the IP version can include IPv4 and/or IPv6.

Additionally, while FIGS. 1A and 1B depicted a typical multi-processor host system, a wide variety of other multi-processor architectures may be used. For example, while the systems illustrated did not feature TOEs, an implementation may nevertheless feature them. Such TOEs may participate in the scheme described above (e.g., a TOE processor may have its own associated state data). Further, the different processors 102a-102n illustrated in FIGs. 1A and 1B can be different central processing units (CPU), different programmable processor cores integrated on the same die, and so forth.

The term circuitry as used herein includes hardwired circuitry, digital circuitry, analog circuitry, programmable circuitry, and so forth. The programmable circuitry may operate on computer programs.

Other embodiments are within the scope of the following claims.

What is claimed is:

1. A method comprising, at different times:
comparing multiple reachability measures of a remote device; and
if the reachability measures of the remote device differ, setting the reachability measures of the remote device to the same value.

2. The method of claim 1, wherein the reachability measures of the remote device comprise reachability measures associated with different, respective, processors in a multiple processor system.

3. The method of claim 2, further comprising:
determining, at a one of the multiple processors, if a packet received via the remote device advances a receive window of the packet's connection; and
updating the reachability measure for the remote device associated with the one of the multiple processors.

4. The method of claim 1, wherein the reachability measure comprises a reachability delta.

5. The method of claim 4, further comprising
periodically incrementing each of the reachability deltas for the remote device.

6. The method of claim 1, further comprising:
accessing a one of the reachability measures of the remote device; and
comparing the reachability measure to a threshold.

7. A method, comprising:
receiving a Transmission Control Protocol (TCP) packet via a remote media access controller (MAC);
mapping the packet to a one of a set of multiple processors based on the packet's connection;
determining, at the mapped one of the set of multiple processors, whether the received packet advances a receive window of the packet's TCP connection;
if it is determined that the received packet advances the receive window of the packet's TCP connection, resetting a delta for the remote media access controller in one of multiple sets of state data associated with the multiple, respective, processors; and
at different times:
comparing the delta values for a remote media access controllers across the multiple sets of state data;
if the remote media access controller has different delta values across the multiple sets of state data, setting the delta values for the remote media access controller to the lowest of the delta values for the remote media access controller across the multiple sets of state data; and
incrementing the delta values for the remote media access controller across the multiple sets of state data.

8. The method of claim 7, further comprising:
accessing the delta of a remote media access controller in the state data associated with a one of the processors; and
comparing the delta to a threshold.

9. The method of claim 7, wherein the determining one of the set of processors comprises determining based, at least in part, on the packet's Internet Protocol (IP) source and destination addresses and the packet's TCP source and destination ports.

10. A computer program, disposed on a computer readable medium comprising instructions for causing a processor to:
compare multiple reachability measures of a remote media access controller; and
if the measures of the remote media access controller differ, setting the reachability measures to the same value.

11. The program of claim 10, wherein the reachability measures of the media access controller comprise measures associated with different processors in a multiple processor system.

12. The program of claim 11, further comprising instructions to:
determine, at a one of the multiple processors, if a packet received via the media access controller advances a receive window of the packet's connection; and
update the reachability measure for the media access controller associated with the one of the multiple processors.

13. The program of claim 11, further comprising instructions to:
periodically increment each of the deltas for the media access controller.

14. The program of claim 10, further comprising instructions to:
access the reachability measure of the media access controller; and
compare the measure to a threshold.

15. A system comprising:
multiple processors;
memory;
at least one network interface controller;
a chipset interconnecting the multiple processors, memory, and the at least one network interface controller; and
a computer program product, disposed on a computer readable medium, for causing at least one of the multiple processors to:
compare reachability measures of a device across multiple sets of state data associated with the multiple, respective, processors; and
if the reachability measures of the device differ across the multiple sets of state data, setting the reachability measures of the device across the multiple sets of neighbor state data to the same value.

16. The system of claim 15, wherein the reachability measure comprises a reachability delta.

17. The system of claim 15, wherein the instructions further comprise instructions for causing at least one of the processors to, at repeated intervals, increment each of the reachability measures of each devices in the multiple sets of neighbor state data.

18. The system of claim 15, wherein the instructions further comprise instructions for causing multiple ones of the processors to:
reset the reachability measure in the state data associated with the one of the multiple processors based on a received packet.

19. The system of claim 18, wherein the instructions to reset the reachability measure based on the received packet comprises determining if the packet advances a receive window of the packet's connection.

20. The system of claim 15, wherein the reachability measure comprises at least one selected from the following group: a measure of the last packet received from the device and a measure of the last packet received from the device that advanced the receive window of the connection of the last packet.

21. The system of claim 15, wherein the reachability measure comprises a timestamp.

22. The system of claim 15, wherein the device comprises at least one of the following group: a remote media access controller and a remote host of having a network address.
